(19) United States
(12) Patent Application Publication
(10) Pub. No.: US 2013/0251028 A1
(43) Pub. Date: Sep. 26, 2013

(54) VIDEO ENCODING AND DECODING WITH CHANNEL PREDICTION AND ERROR CORRECTION CAPABILITY

(71) Applicant: THE HONG KONG UNIVERSITY OF SCIENCE AND TECHNOLOGY, Kowloon (HK)

(72) Inventors: Oscar Chi Lim AU, Kowloon (HK); Xingyu ZHANG, Kowloon (HK)

(73) Assignee: THE HONG KONG UNIVERSITY OF SCIENCE AND TECHNOLOGY, Kowloon (HK)

(21) Appl. No.: 13/848,345

(22) Filed: Mar. 21, 2013

Related U.S. Application Data
(60) Provisional application No. 61/685,671, filed on Mar. 22, 2012.

(51) Int. Cl. H04N 7/26

(52) U.S. Cl. CPC H04N 19/00018
USPC 375/240.02

(57) ABSTRACT

Data encoding and/or decoding techniques are applied in a codec system. Pixel parameters and error thresholds can be determined. A prediction mode can be determined. Further, a prediction mode can predict values of an encoded and/or decoded media item. In one aspect, compositions of media items can determine prediction modes.

This application claims priority to U.S. Provisional Patent Application No. 61/685,671, filed on Mar. 22, 2012, entitled “PARAMETER CORRECTION FOR LM MODE IN CHROMA INTRA PREDICTION.” The entirety of the aforementioned application is incorporated by reference herein.

### TECHNICAL FIELD

This disclosure relates generally to image and video encoding and decoding in connection with a codec system, e.g., the compression and decompression of data in an image and video system.

### BACKGROUND

The amount of data representing media information, such as still image and video images, can be extremely large. Further, transmitting digital video information over networks can consume large amounts of bandwidth. The cost of transmitting data from one location to another is a function of number of bits transmitted per second. Typically, higher bit transfer rates are associated with increased cost. Higher bit rates also progressively add to required storage capacities of memory systems, thereby increasing storage cost. Thus, at given quality level, it is more cost effective to use fewer bits, as opposed to more bits, to store digital images and videos.

It is therefore desirable to compress media data for recording, transmitting, and storing. For a typical compression scheme, the general result is that achieving higher media quality requires more bits used, which, in turn, increases cost of transmission and storage. Moreover, while lower bandwidth traffic is desired, so is higher quality media. Existing systems and or methods have limited efficiency and effectiveness.

A codec is a device capable of coding and/or decoding digital media data. The term codec is derived from a combination of the terms code and decode, or compress and decompress. Codecs can reduce number of bits required to transmit signals thereby reducing associated transmission costs. A variety of codecs are commercially available. Generally speaking, for example, codec classifications include discrete cosine transfer codecs, fractal codecs, and wavelet codecs.

In general, lossless data compression amounts to reducing or removing redundancies that exist in data. Further, media information can be compressed with information loss even if there are no redundancies. This compression scheme relies on an assumption that some information can be neglected. Under such scheme, image and video features that the human eye is not sensitive to are removed and features that the eye is sensitive to are retained.

Video compression techniques and devices can employ an encoding scheme based on motion compensation and transformation. For example, according to a conventional process of encoding video information, a digital video signal undergoes intra prediction or inter prediction using motion compensation to produce a residual signal. Then, the residual signal is converted to transform coefficients using a transform algorithm, following which the transform coefficients are quantized. Then entropy encoding, such as variable length coding, or arithmetic coding, is performed on the quantized transform coefficient. To decode, an entropy decoder converts compressed data from an encoder to coding modes, motion vectors, and quantized transform coefficients. The quantized transform coefficients are inverse-quantized and inverse-transformed to generate the residual signal, and then a decoded image is reconstructed by compositing the residual signal with a prediction signal using coding modes and motion vectors, and stored in memory. At a given bit rate, the amount of difference between video input and reconstructed video output is an indication of quality of compression technique.

The above-described background is merely intended to provide a contextual overview of one or more conventional systems, and is not intended to be exhaustive.

### BRIEF DESCRIPTION OF THE DRAWINGS

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other distinctive elements of the disclosed subject matter will become apparent from the following detailed description of the various embodiments when considered in conjunction with the drawings.

Non-limiting and non-exhaustive embodiments of the subject disclosure are described with reference to the following figures, wherein like reference numerals refer to like parts throughout the various views unless otherwise specified.

FIG. 1 illustrates a high level functional block diagram of a codec system in accordance with various embodiments.

FIG. 2 illustrates a functional illustration of current block and reference blocks utilized for prediction management in accordance with various embodiments.

FIG. 3 presents a high level block diagram of a codec system including an error detection component, in accordance with various embodiments.

FIG. 4 illustrates a high level block diagram of analyzed current blocks in accordance with various embodiments.

FIG. 5 illustrates a high level schematic diagram of a codec system, including an error component and an output component, in accordance with various embodiments.

FIG. 6 illustrates a flow diagram of a method for predicting pixel values in accordance with an embodiment.

FIG. 7 illustrates a flow diagram of a method for generating prediction values in accordance with an embodiment.

FIG. 8 illustrates a flow diagram of a method for detecting errors during and encoding and/or decoding process in accordance with various embodiments.

FIG. 9 illustrates a flow diagram of predicting pixel values and detecting errors in accordance with various embodiments.

FIG. 10 illustrates an example block diagram of a computer operable to execute various aspects of this disclosure in accordance with the embodiments disclosed herein.

FIG. 11 illustrates an example block diagram of a networked environment capable of encoding and/or decoding data in accordance with the embodiments disclosed herein.

### DETAILED DESCRIPTION

In the following description, numerous specific details are set forth to provide a thorough understanding of the embodiments. It is noted, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular element, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular elements, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

Moreover, the word “exemplary” where used herein to means serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Embodiments of the invention may be used in a variety of applications. Some embodiments of the invention may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, a wireless communication station, a wireless communication device, a wireless access point (AP), a modem, a network, a wireless network, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or long term evolution (LTE) of the above standards, units and/or devices which are part of the above networks, one way and/or two-way radio communication systems, cellular radio-telephone communication systems, a cellular telephone, a wireless telephone, a personal communication systems (PCS) device, a PDA device which incorporates a wireless communication device, a multiple input multiple output (MIMO) transceiver or device, a single input multiple output (SIMO) transceiver or device, a multiple input single output (MISO) transceiver or device, or the like.

As an overview, compression and decompression of data techniques and systems are described. In one aspect, a device can dynamically manage data compression based on reference pixels. For example, a device can determine pixels to use as reference pixels for intra-channel prediction, and the like. The device can determine to use the one or more pixels based on composition of an image. In another aspect, the device can utilize metrics or parameters, to determine and select the pixels.

A device can manage error detection and correction in encoding and decoding videos. For example, a device can determine if a parameter meets threshold conditions that are determined to signify an error in prediction. In another aspect, the device can encode and/or decode data and simultaneously adjust parameters to correct identified errors.

The term “codec,” as used herein in, generally refers to a component that can encode and/or decode information through compression and decompression. Encoding and decoding can include data quantization, transforming, and the like. It is noted that “encode,” “encoding,” and the like, generally refer to representing a media item as compressed data. Likewise, “decode,” “decoding,” and the like, generally refer to decompression of compressed data into a media item. However, for readability, various embodiments can refer to “encode,” and/or “decode,” unless context suggests otherwise.

Generally, video refers to a sequence of still images or frames that are capable of display in relatively quick succession, thereby causing a viewer to perceive motion. Each frame may comprise a plurality of picture elements or pixels, each of which may represent a single reference point in the frame. During digital processing, each pixel may be assigned an integer value (e.g., 0, 1, etc.) that represents an image quality or characteristic, such as luminance (luma) or chrominance (chroma), at the corresponding reference point. In use, an image or video frame may comprise a relatively large amount of pixels (e.g., 2,073,600 pixels in a 1920×1080 frame), thus it may be cumbersome and inefficient to encode and decode (referred to hereinafter simply as code) each pixel independently. To improve coding efficiency, a video frame can broken into a plurality of rectangular blocks or macroblocks, which may serve as basic units of processing such as prediction, transform, and quantization. For example, a typical N×N block may comprise N pixels, where N is an integer greater than one and is often a multiple of four.

High Efficiency Video Coding (HEVC) is a video standard, and introduces new block concepts. For example, coding unit (CU) may refer to a sub-partitioning of a video frame into rectangular blocks of equal or variable size. In HEVC, a CU may replace a macroblock structure of previous standards. Depending on a mode of inter or intra prediction, a CU may comprise one or more prediction units (PUs), each of which may serve as a basic unit of prediction. For example, for intra prediction, a 64×64 CU may be symmetrically split into four 32×32 PUs. For another example, for an inter prediction, a 64×64 CU may be asymmetrically split into a 16×64 PU and a 48×64 PU. Similarly, a PU may comprise one or more transform units (TUs), each of which may serve as a basic unit for transform and/or quantization. For example, a 32×32 PU may be symmetrically split into four 16×16 TUs. Multiple TUs of one PU may share a same prediction mode, but may be transformed separately. Herein, the term block may generally refer to any of a macroblock, CU, PU, or TU. In an implementation, each CU, PU, and TU can correspond to a luma component and/or chroma component. It is noted that blocks can be divided in various manners, such as quad-tree structures. Likewise, blocks need not be rectangular. It is noted that each block can correspond to a region of an image frame. Blocks can be processed in a Z-scan order. In intra frame coding, directional intra prediction is performed at the TU level. But all TUs within a PU share the same intra prediction mode. After intra prediction, transform is performed at TU level with the transform size equal to the TU size.

As an example, assuming YCbCr 4:2:0 color format, the chroma LCU, CU, PU and TU are typically half that of the luma equivalent, i.e. a 2N×2N luma block corresponds to a N×N chroma block. Some exceptions exist due to the smallest chroma block size of 4×4. If a 8×8 luma block is divided into blocks smaller than 8×8, the corresponding chroma block will not be divided and will stay at 4×4. Similar to luma processing, chroma intra prediction is performed at the TU level though all TUs within a PU share the same prediction mode. Transform is performed at TU level.

Within a video frame, a pixel may be correlated with other pixels within the same frame such that pixel values within a block or across some blocks may vary only slightly and/or exhibit repetitious textures. Video-compression, as described herein, can exploit these spatial correlations using various techniques through intra-frame prediction. Intra-frame prediction may reduce spatial redundancies between neighboring blocks in the same frame, thereby compressing the video data without greatly reducing image quality.

Systems and methods disclosed herein relate to encoding and/or decoding of media content. A prediction component determines a prediction mode for encoding and/or decoding. The prediction mode can be determined based on a composition of a video, composition of a macroblock and neighboring macroblocks, composition of chromo blocks, luma blocks, and the like. In exemplary embodiments, the prediction mode is utilized to encode and/or decode media items and/or compressed data.

In various implementations, an error detection component detects errors in compressed data. In an aspect, the error detection component can detect macroblocks having a composition likely to cause errors in encoding and/or decoding. In another aspect, the error detection component can detect errors based on parameters of a macroblock and can adjust parameters to alter, reduce and/or remove errors in a codec system.

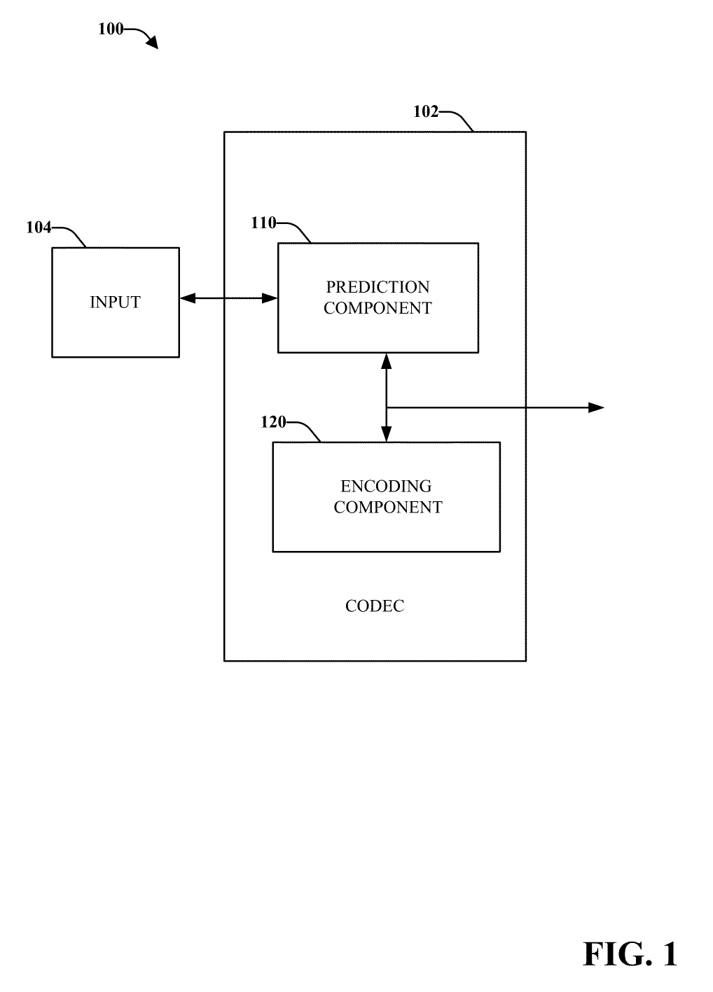

FIG. 1 illustrates a codec system 100 in accordance with various embodiments. Aspects of the systems, apparatuses, or processes explained herein can constitute machine-executable components embodied within machine(s), e.g., embodied in one or more computer readable mediums (or media) associated with one or more machines. Such component, when executed by the one or more machines, e.g., computer(s), computing device(s), virtual machine(s), etc., can cause the machine(s) to perform the operations described. The system 100 illustrated in FIG. 1 can include a codec component 102. The codec component 102 can include a prediction component 110 and an encoding component 120. The codec component 102 can receive input 104. The input 104 can be a media item, such as video, audio, still image, and/or a combination. In an aspect, the input can be captured from an image capturing device (e.g., a camera). In another aspect, the input 104 can be received from various systems, over a network, and/or the like. It is noted that the media item can be content encoded in various formats (YCbCr 4:2:0, MPEG, MPEG3, etc.). In another aspect, the input can comprise data representing a media item, such as quantized data, and the like.

The prediction component 110, can utilize intra-frame prediction to interpolate a prediction block (or predicted block) from one or more previously coded/decoded neighboring blocks, thereby creating an approximation of the current block. In another aspect, the prediction component 110 can determine a prediction mode to utilize for intra-frame prediction.

In an aspect, the prediction component 110 can obtain color components from image frames (e.g., chroma and/or luma components). In another aspect, prediction component 110 can obtain the color components by performing transforms on data having red, green, and blue (RGB), YUV, YCbCr, YIQ, XYZ, etc, components.

In an aspect, the prediction component 110 can determine a prediction mode based on a determined inter-color (or inter-channel) correlation. In an example, the prediction component 110 can determine inter-channel correlation in an RGB signal (e.g., all three of the R, G, B components contain high energy and high bandwidth), and/or other formats.

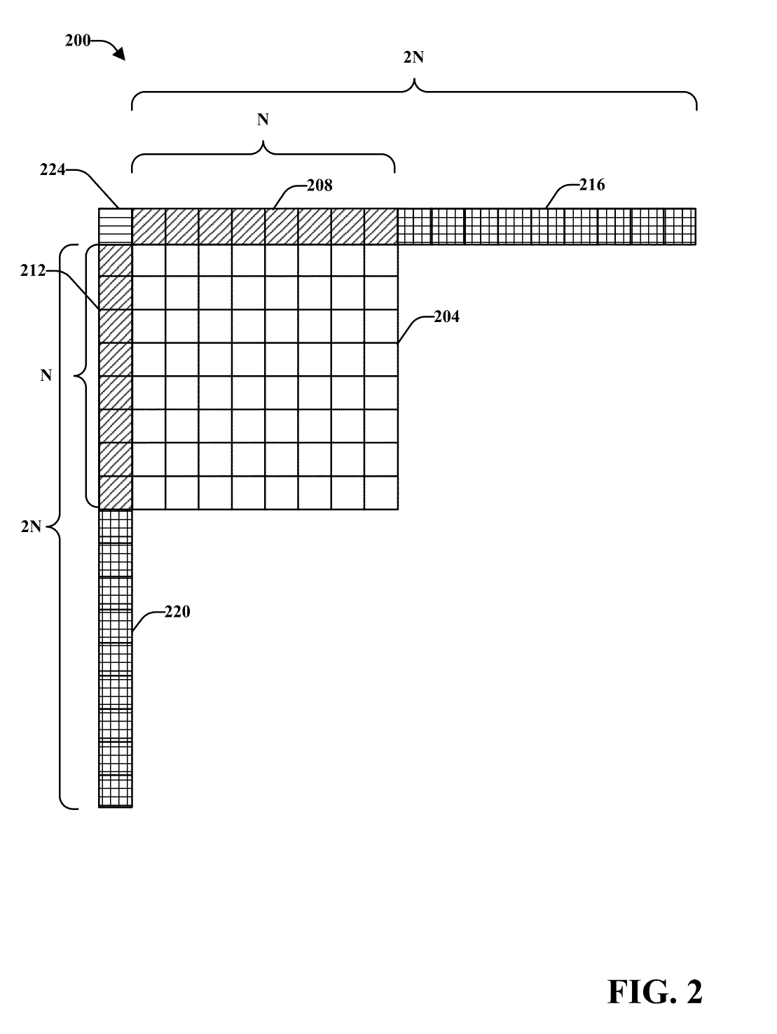

Referring now to FIG. 2, a graphical depiction of a prediction system 200 is illustrated. In an aspect, a prediction block 204 can be a N×N block, where N is a number. External reference pixels are utilized to predict the prediction block 204. The external reference blocks can for an L shape. As depicted, a row 208 of N top neighboring blocks, a row 216 of N top blocks to the right of row 208, a column 212 of N left neighboring blocks, a column 220 of N blocks below column 212, and a top left corner block 224 can be utilized as reference blocks. It is noted that while 4N+1 reference blocks are depicted, an alternative number of reference blocks can be utilized.

Turning to FIG. 1, with reference to FIG. 2, the prediction component 110 can determine values for the external reference blocks. If one or more of the external reference blocks are missing, the prediction component 110 can pad the missing external reference block with a determined value.

The prediction component 110 can utilize a plurality of prediction modes, such as a direct mode (DM), linear mode (LM), planar mode, vertical mode, horizontal mode, direct current (DC) mode, and the like. It is noted that various directional variations can be utilized for prediction (e.g., in planar mode).

In an aspect, the prediction component 110 can utilize reconstructed pixels to predict pixels of a disparate channel. As an example, the prediction component 110 can utilize reconstructed luma pixels to predict chroma pixels. It is noted, that the prediction component 110 can utilize disparate prediction modes and directions for chroma channels, luma channels, and/or individual prediction blocks. In an aspect, the external reference blocks can comprise reconstructed pixels.

The prediction component 110 can utilize a LM prediction mode, for example, to predict chroma pixel values based on luma pixel values. As an example, a Y component of a YCbCr formatted video can predict values of a Cb component and/or Cr component. While this disclosure refers to predicting Cb components, it is noted that the Cr component can be predicted in a similar and/or identical manner. Continuing with the example, assume B_{c} is an N×N Cb chroma block and B′ₗ is a corresponding 2N×2N luma block. The prediction component can down-sample B′ₗ to a N×N block referred to as Bₗ. Further assume c_{i,j} and l_{i,j} are the ij^{th} element of B_{c} and Bₗ respectively, where i, j=0, 1, . . . , N−1. It is noted that i and/or j can be negative, wherein a negative number represents a neighboring block, and/or external reference block. In an example, B_{c} and Bₗ can be converted into M×l row-ordered vectors, x and y, such that:

x_{iN+j}=l_{i,j};i,j=0,1, . . . ,N−1 (1)

y_{iN+j}=c_{i,j};i,j=0,1, . . . ,N−1 (2)

where xₖ and yₖ are the k^{th} component of x and y respectively for k=0, 1, . . . , M−1, and where M=N². The prediction component 110 can determine a linear predictor of y is formed from x as follows:

y=αx+βI_{M} (3)

where a slope (α) and an offset (β) are scalar. Further, Iₖ can represent a k×l vector with all elements being 1, for any k. Or equivalently,

ŷₖ=αxₖ+β;k=0,1, . . . ,M−1 (4)

ĉ_{i,j}=αl_{i,j}+β;i,j=0,1, . . . ,N−1 (5)

By taking derivative with respect to α and β and setting them to zero, the mean square estimation error

$$\begin{matrix}{D}_{0} ( α , β ) = {\vert y - y \vert}_{2}^{2} \\ = {\vert y - α x - β {I}_{M} \vert}_{2}^{2} ( 7 )\end{matrix} \qquad ( 6 )$$

can be minimized with

$$\begin{matrix}{α}_{0} = \frac{{x}^{T} y ( {I}_{M}^{T} {I}_{M} ) - ( {x}^{T} {I}_{M} ) ( {y}^{T} {I}_{M} )}{( {x}^{T} x ) ( {I}_{M}^{T} {I}_{M} ) - {( {x}^{T} {I}_{M} )}^{2}} & ( 8 ) \\ {β}_{0} = \frac{{y}^{T} {I}_{M} - α ( {x}^{T} {I}_{M} )}{{I}_{M}^{T} {I}_{M}} & ( 9 )\end{matrix}$$

or equivalently,

$$\begin{matrix}\begin{matrix}{α}_{0} = \frac{M \cdot {\sum }_{k = 0}^{M - 1} {x}_{k} {y}_{k} - {\sum }_{k = 0}^{M - 1} {x}_{k} {\sum }_{k = 0}^{M - 1} {y}_{k}}{M {\sum }_{k = 0}^{M - 1} {x}_{k}^{2} - {( {\sum }_{k = 0}^{M - 1} {x}_{k} )}^{2}} \\ = \frac{\frac{1}{M} {\sum }_{k = 0}^{M - 1} {x}_{k} {y}_{k} - ( \frac{1}{M} {\sum }_{k = 0}^{M - 1} {x}_{k} ) ( \frac{1}{M} {\sum }_{k = 0}^{M - 1} {y}_{k} )}{\frac{1}{M} {\sum }_{k = 0}^{M - 1} {x}_{k}^{2} - {( \frac{1}{M} {\sum }_{k = 0}^{M - 1} {x}_{k} )}^{2}}\end{matrix} & ( 10 ) \\ {β}_{0} = \frac{1}{M} {\sum }_{k = 0}^{M - 1} {y}_{k} - α ( \frac{1}{M} {\sum }_{k = 0}^{M - 1} {x}_{k} ) & ( 11 )\end{matrix}$$

As used above, the subscript 0 to indicate quantities computed using the current block data, such that D₀ is the distortion function of the current block B_{c}, and α₀ and β₀ are the corresponding optimal linear parameters. In an aspect, α₀ and β₀ are needed at both the encoder and decoder to form the predictor y. It is noted that, α₀ and β₀ can be quantized and communicated, the overhead to send them can be significant. However, in the LM mode of HEVC, the α₀ and β₀ are not sent. Instead, they are computed approximately using the neighboring decoded pixels.

In another aspect, the prediction component can determine luminance components of N×1 vectors. The N×1 vectors can comprise the column 212 (more., the column 220, the row 208, and the row 216 or more generally, a left neighbor bₗ, a bottom left neighbor b_{lb}, a top neighbor bₜ, and a top right neighbor bₜᵣ, respectively. As an example, four N×1 vectors xₜ, xₜᵣ, xₗ and x_{lb} can represent components of the luminance components of bₜ, bₜᵣ, bₗ and b_{lb} respectively. Similarly, four N×1 vectors yₜ, yₜᵣ, yₗ and y_{lb} can represent the corresponding chrominance components.

In another aspect, the L-shape border formed by the top pixels (bₜ) and left pixels (bₗ) can be utilized to derive the α and β. As an example, Let xₗₘ and yₗₘ be 2N×1 vectors representing the luminance and chrominance components of these border pixels.

$${x}_{lm} = ( \begin{matrix}{x}_{t} \\ {x}_{l}\end{matrix} ) ; {y}_{lm} = ( \begin{matrix}{y}_{t} \\ {y}_{l}\end{matrix} ) \qquad ( 12 )$$

The linear predictor of yₗₘ is formed from xₗₘ as follows:

yₗₘ=αxₗₘ+βI_{2N} (13)

Let x_{lm,k} and y_{lm,k} be the k^{th} element of xₗₘ and yₗₘ respectively. Taking derivative with respect to α and β and setting them to zero, the mean square estimation error

Dₗₘ(α,β)=|yₗₘ−yₗₘ|₂² (14)

can be minimized with

$$\begin{matrix}{α}_{lm} = \frac{{x}_{lm}^{T} {y}_{lm} ( {I}_{2 N}^{T} {I}_{2 N} ) - ( {x}_{lm}^{T} {I}_{2 N} ) ( {y}_{lm}^{T} {I}_{2 N} )}{( {x}_{lm}^{T} {x}_{lm} ) ( {I}_{2 N}^{T} {I}_{2 N} ) - {( {x}_{lm}^{T} {I}_{2 N} )}^{2}} & ( 15 ) \\ {β}_{lm} = \frac{{y}_{lm}^{T} {I}_{2 N} - {α}_{lm} ( {x}_{lm}^{T} {I}_{2 N} )}{{I}_{2 N}^{T} {I}_{2 N}} . & ( 16 )\end{matrix}$$

Accordingly, α₀ and β₀ are not sent but rather the prediction component 110 computes αₗₘ and βₗₘ using the reconstructed border pixels at both an encoder and decoder, and uses αₗₘ and βₗₘ to approximate α₀ and β₀ in order to form the estimate y. The underlying assumption of the LM mode is that the characteristics between x and y is the same as that between xₗₘ and yₗₘ. In an implementation, the prediction component 110 can determine parameters of prediction blocks. The parameters can include, for example, slopes, offsets, parameters utilized to determine slopes and offsets, and the like. As an example, A₁ and A₂ can be the numerator and denominator of Eqn. (15) respectively such that αₗₘ=A₁/A₂. Represented as an equation, wherein M′=2N, A₁ and A₂ can be:

$$\begin{matrix}\begin{matrix}{A}_{1} = {x}_{lm}^{T} {y}_{lm} ( {I}_{2 N}^{T} {I}_{2 N} ) - ( {x}_{lm}^{T} {I}_{2 N} ) ( {y}_{lm}^{T} {I}_{2 N} ) \\ = {M}^{′} {\sum }_{k = 0}^{{M}^{′} - 1} {x}_{lm , k} {y}_{lm , k} - {\sum }_{k = 0}^{{M}^{′} - 1} {x}_{lm , k} {\sum }_{k = 0}^{{M}^{′} - 1} {y}_{lm , k}\end{matrix} & ( 17 ) \\ \begin{matrix}{A}_{2} = ( {x}_{lm , k}^{T} {x}_{lm , k} ) ( {I}_{2 N}^{T} {I}_{2 N} ) - {( {x}_{lm}^{T} {I}_{2 N} )}^{2} \\ = {M}^{′} {\sum }_{k = 0}^{{M}^{′} - 1} {x}_{lm , k}^{2} - ( {\sum }_{k = 0}^{{M}^{′} - 1} {{x}_{lm , k}}^{2} )\end{matrix} & ( 18 )\end{matrix}$$

In an implementation, the prediction component 110 can determine a prediction mode as a function of a determined importance level of external reference blocks and/or vectors (e.g., row 208, row 216, column 212, and column 220).

As an example, the prediction component 110 can define weighting vectors associated with prediction vectors, bₜ, bₜᵣ, bₗ and b_{lb}. In an aspect, a set of weighting vectors can comprise vectors wₜ, wₜᵣ, wₗ and w_{lb} associated with bₜ, b_{tr,} bₗ and b_{lb} respectively. In one aspect, the weighting vectors can be represented as a matrix. With reference to FIG. 2, a diagonal matrix (Q) can be a 4N×4N matrix with the diagonal elements being the weights of the shaded reference blocks. Represented as an equation,

$$diag ( Q ) = ( \begin{matrix}{w}_{lb} \\ {w}_{l} \\ {w}_{t} \\ {w}_{tr}\end{matrix} ) ; \qquad ( 19 )$$

In an implementation, equation 19 can yield Qₜ, Qₜᵣ, Qₗ, and Q_{lb} as four N×N diagonal matrices with diagonal elements being wₜ, wₜᵣ, wₗ and w_{lb} respectively. Let Q₂=Q²=QQ such that Q₂ is a diagonal matrix with the diagonal elements being the square of the weights. As such, the luma and chroma components of the border pixels form two 4N×1 vectors x_{b} and y_{b}, and the chroma predictor y_{b} can be represented as

$${y}_{b} = α {x}_{b} + β Ib ; {x}_{b} = ( \begin{matrix}{x}_{lb} \\ {x}_{l} \\ {x}_{t} \\ {x}_{tr}\end{matrix} ) ; {y}_{b} = ( \begin{matrix}{y}_{lb} \\ {y}_{l} \\ {y}_{t} \\ {y}_{tr}\end{matrix} ) ; \qquad ( 20 )$$

where Ib=I_{4N}. Then, the mean square estimation error can be represented as:

$$\begin{matrix}D = {\vert Q ( {y}_{b} - {y}_{b} ) \vert}_{2}^{2} \\ = {\vert Q ( {y}_{b} - α {x}_{b} - β Ib ) \vert}_{2}^{2} ( 22 )\end{matrix} \qquad ( 21 )$$

and can be minimized with:

$$\begin{matrix}α = \frac{( {y}_{b}^{T} {Q}_{2} {x}_{b} ) ( {I}_{b}^{T} {Q}_{2} {I}_{b} ) - ( {x}_{b}^{T} {Q}_{2} {I}_{b} ) ( {y}_{b}^{T} {Q}_{2} {I}_{b} )}{( {x}_{b}^{T} {Q}_{2} {x}_{b} ) ( {I}_{b}^{T} {Q}_{2} {I}_{b} ) - {( {x}_{b}^{T} {Q}_{2} {I}_{b} )}^{2}} & ( 23 ) \\ β = \frac{{y}_{b}^{T} {Q}_{2} {I}_{b} - α {x}_{b}^{T} {Q}_{2} {I}_{b}}{{I}_{b}^{T} {Q}_{2} {I}_{b}} & ( 24 )\end{matrix}$$

where the individual terms can be expressed as follows:

$${y}_{b}^{T} {Q}_{2} {x}_{b} = {y}_{lb}^{T} {Q}_{lb}^{2} {x}_{lb} + {y}_{l}^{T} {Q}_{l}^{2} {x}_{l} + {y}_{t}^{T} {Q}_{t}^{2} {x}_{t} + {y}_{tr}^{T} {Q}_{tr}^{2} {x}_{tr}$$

$${x}_{b}^{T} {Q}_{2} {x}_{b} = {x}_{lb}^{T} {Q}_{lb}^{2} {x}_{lb} + {x}_{l}^{T} {Q}_{l}^{2} {x}_{l} + {x}_{t}^{T} {Q}_{t}^{2} {x}_{t} + {x}_{tr}^{T} {Q}_{tr}^{2} {x}_{tr}$$

$${x}_{b}^{T} {Q}_{2} {I}_{b} = {x}_{lb}^{T} {Q}_{lb}^{2} {I}_{N} + {x}_{l}^{T} {Q}_{l}^{2} {I}_{N} + {x}_{t}^{T} {Q}_{t}^{2} {I}_{N} + {x}_{tr}^{T} {Q}_{tr}^{2} {I}_{N}$$

$${y}_{b}^{T} {Q}_{2} {I}_{b} = {y}_{lb}^{T} {Q}_{lb}^{2} {I}_{N} + {y}_{l}^{T} {Q}_{l}^{2} {I}_{N} + {y}_{t}^{T} {Q}_{t}^{2} {I}_{N} + {y}_{tr}^{T} {Q}_{tr}^{2} {I}_{N}$$

$$\begin{matrix}{I}_{b}^{T} {Q}_{2} {I}_{b} = {I}_{N}^{T} {Q}_{lb}^{2} {I}_{N} + {I}_{N}^{T} {Q}_{l}^{2} {I}_{N} + {I}_{N}^{T} {Q}_{t}^{2} {I}_{N} + {I}_{N}^{T} {Q}_{tr}^{2} {I}_{N} \\ = {w}_{lb}^{T} {w}_{lb} + {w}_{l}^{T} {w}_{l} + {w}_{t}^{T} {w}_{t} + {w}_{tr}^{T} {w}_{tr}\end{matrix}$$

These will degenerate to αₗₘ and βₗₘ of the LM mode if w_{lb}=wₜᵣ=0_{N} and wₗ=wₜ=I_{N}, where 0_{N} is an N×1 vector with all elements being 0.

In various implementations, the prediction component 110 can determine a prediction mode to apply based on inner and outer borders to achieve a inter-channel linear prediction (e.g., row 208 and column 212 can be inner borders, and row 216 and column 220 can be outer borders). In an aspect, addition prediction models can be a LM mode using the left (e.g., 212) and left-below (e.g., 220) borders only (LML mode), LM mode using top (e.g., 208) and top-right (e.g., 216) borders only (LMA mode), and LM using outer borders (e.g., 220, and 216) only (LMO mode).

It is noted that prediction modes LML, LMA and LMO are described herein for illustrative purposes. Various other implementations of this disclosure can apply prediction modes that utilize select reference pixels based on analyzed parameters of a current block, and/or reference blocks. It is noted, that the various modes can apply a select importance level and/or weighting technique. In an aspect, the weighting can be based on the mode, parameters, composition of a current block, composition of reference blocks and the like. As described herein, LML mode is described with w_{lb}=wₗ=I_{N}, wₜ=wₜᵣ=0_{N} such that I_{b}^{T}Q₂I_{b}=2N. The corresponding optimal α and β will be called αₗₘₗ and lβₗₘₗ. The LMA mode is described with w_{lb}=wₗ=0_{N}, wₜ=wₜᵣ=I_{N}. The corresponding optimal α and β will be called αₗₘₐ and βₗₘₐ. Additionally, the LMO mode is described with wₗ=wₜ=0_{N}, w_{lb}=wₜᵣ=I_{N}. The corresponding optimal α and β will be called αₗₘₒ and βₗₘₒ. It is noted that the prediction component 110 can utilized 2N border pixels to determine a α and β. In an aspect, a decoder complexity of LM, LMA, LML and LMO can be the same, regardless of which mode is being chosen. However, in various aspects, more or less border pixels can be utilized.

The encoding component 120 can encode the data in a bit stream, e.g. entropy encoding, and send the bit stream to another device. In another example, encoding component 120 may send data to a buffer that may in turn, sends data to be stored in a different memory. It is noted that encoding component 120 can perform quantization, transformations, and the like, in order to encode the input 104. In an aspect, the encoder can encode meta data, including types of prediction modes used.

It is noted that prediction schemes disclosed herein may be implemented in a variety of coding schemes. Depending on the application, lossy (i.e., with distortion or information loss) and/or lossless (i.e., no distortion or information loss) encoding may be implemented in a video encoder. Herein, a lossy encoding can include quantization without transform encoding and lossless encoding can include transform bypass encoding and transform without quantization encoding.

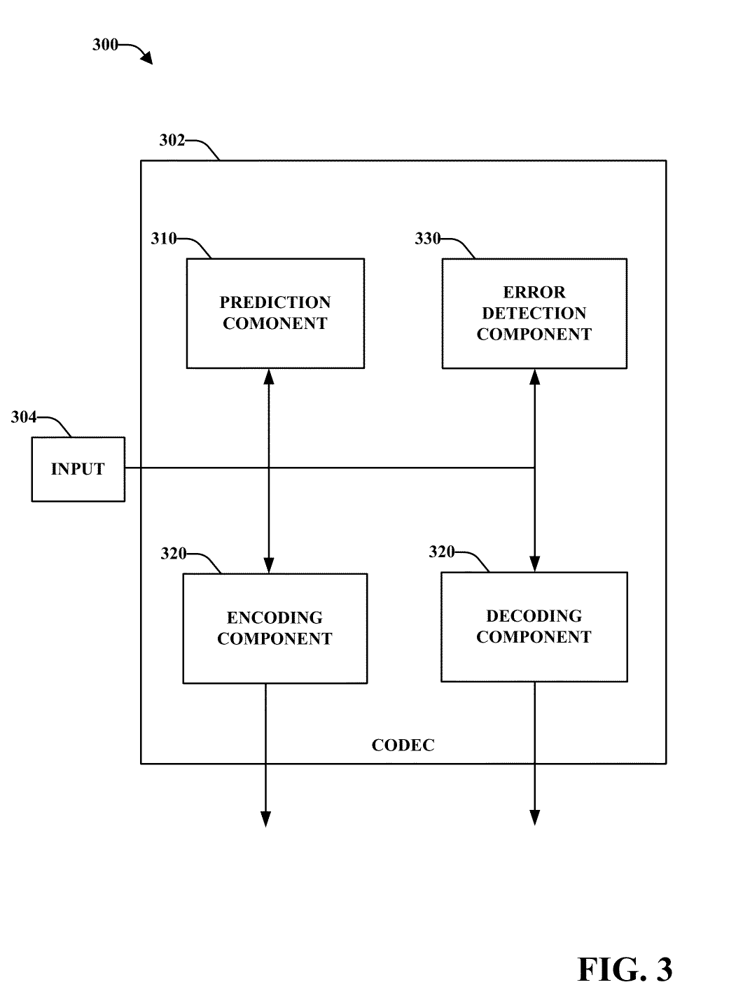

Referring now to FIG. 3, presented is a high level block diagram of a codec system 300 configured to encode data with based on a prediction mode. As seen in FIG. 3, system 300 includes a prediction component 310, an encoding component 320, a decoding component 322, and a error detection component 330. It is noted that the codec system 300 can be comprised in various computing devices, such as personal computers, tablet computers, smart phones, set top boxes, desktop computers, laptops, gaming systems, servers, data centers, and the like. Further, the codec system 300 can communicate with various systems via a network, such as one or more of the Internet, an intranet, a cellular network, a home network, a person area network, satellite, through an ISP, cellular, or broadband cable provider, and the like. It is noted that codec system 300 can comprise a plurality of other components and is depicted, without such components, for illustrative purposes.

The system 300 can employ encoding and/or decoding methods to encode and/or decode an input 304. Various prediction modes can be implemented for intra-frame and/or intra-channel prediction. It is noted that the input 304 can comprise a data stream, a video item, a still image, and/or various digital media items.

In an aspect, the prediction component 310 can determine a prediction mode for the encoding component 320 and/or the decoding component 322. The encoding component 320 can encode data based on the prediction mode. In an aspect, encoding component 320 can perform quantization, transformations, and the like to encode data. The encoding component 320 can encode data representing the input 304 and/or prediction modes.

The decoding component 322 can decode data based on the prediction mode and/or various decoding techniques. In an aspect, the decoding component can determine a prediction mode based on errors detected by the error detection component 330. In another aspect, the decoding component 322 can determine a prediction mode based on data in the input 304.

In various embodiments, the error detection component 330 can detect errors in a data stream and/or based on various parameters. In an aspect, the error detection component 330 can flag a current block (e.g., block 204) and/or various pixels as an error type. Flagging can include setting a token indicating an error is detected. In various embodiments, a flag can indicate a type of error that can be utilized by the prediction component 310 to determine a prediction mode. It is noted that various techniques can utilize disparate parameters and/or representations to determine an error types similar to error type described herein. As such error types presented herein are exemplary error types.

In an example, the error detection component 330 can determine an error based on parameters, such as A₁ and A₂, (numerator and denominator of αₗₘ, respectively). In an aspect, the error detection component 330 can compare values of A₁ and A₂ to determine a slope. In an example, a slope of a straight line and/or near straight line can be determined when the value of A₂ nears zero, or when the value A₁ is relatively larger than A₂. In an aspect, the slope of a straight line can indicate be sensitive to relatively small distortion in the x-direction (luma). Distortion in the luma channel can cause severe problem and such that a αₗₘ highly sensitive to quantization error in the luma pixels. Similarly, when the slope of the straight line is close to zero, with a relatively small A₁, or when A₁ is relatively much smaller than A₂, a small distortion in the y-direction (chroma) can cause severe problem and the resulting αₗₘ. Thus, αₗₘ is highly sensitive to quantization error in the chroma pixels.

In an aspect, the error detection component 330 can detect an error based on a threshold. The error detection component 330 can determine a horizontal threshold (T₁) based on a quantization step size of neighboring blocks (e.g., reference blocks). As an example, the error detection component 330 can determine whether a parameter meets the horizontal threshold (e.g., |A₁|<T₁). In an example, determining whether the parameter meets the threshold can indicate whether slopes are related to a near horizontal lines. It is noted, that T₁ can be a constant, learned using training sequences, and the like. For simplicity of explanation, the above example can be an error type of “1.”

The error detection component 330 can alter a parameter value based on a detected error type. As an example, the detection component can |A₁|<T₁ is determined to be true, the value of α₁ can be adjusted.

In one aspect, adjusted values of α₁ and values of T₁ can be adaptively determined from a number of candidate values and sent to by an encoding component (e.g., the encoding component 320) and/or can be received by a decoding component (e.g., the decoding component 322). In another aspect, the decoding component 322 and/or the encoding component 320 can adaptively determine at values using the same method such that there is no need to send to the values. In another aspect, a replacement value of α₁ and value of T₁ can be set as constants, learned from training data, and the like. In one example, the replacement value of α₁ can be set as a constant zero.

In another example, the error detection component 330 can determine if a slope is near a horizontal line with |A₁|much smaller than an absolute value of A₂ such that αₗₘ is almost zero, referred to herein as error type 2. In an aspect, the error detection component 330 can determine a threshold (T₂) that is utilized to determine whether an error type 2 has occurred. For example, the error detection component 330 can detect whether a condition, |αₗₘ|=|A₁|/A₂<T₂, is met. It is noted that the error detection component 330 can determine T₂ based on the quantization step size of the neighboring blocks, can set T₂ as a constant, can set T₂ based on a training sequences, can adaptively update T₂, can sent T₂ to a decoder. In another aspect, T₂ can be determined by a decoder device and/or an encoder device using the same method such that there is no need to send T₂. In an aspect, the error detection component 330 can alter a value of αₗₘ base don determining the error type 2 exists.

In another aspect, the error type 2 can be divided into sub-cases based on parameter values, such as values of |αₗₘ|. In various implementations, 2P+1 sub-cases can be detected, where P is an integer, and 2P threshold (T₂ⁱ where i=±1, ±2, . . . , ±P) are determined. In an aspect, 2P+1 replacement values of αₗₘ can be determined, as denoted by α₂^{j}, where j=0, ±1, ±2, . . . , ±P. The error detection component 330 can choose T₂^{P}=T₂ and T₂^{-P}=−T₂ when it is determined that |αₗₘ| is under a threshold indicative of a relatively very smaller αₗₘ, such as when the condition T₂⁻¹<αₗₘ<T₂¹ is met. In this case, αₗₘ is replaced by α₂⁰. In another aspect, error detection component 330 can determine a sub-case is met when T₂ⁱ<αₗₘ<T₂ⁱ⁺¹, and can replaceαₗₘ with α₂ⁱ for i=1, 2, . . . , P.

In an aspect, the error detection component 330 can adaptively chose T₂, α₂ⁱ and T₂ⁱ from a number of candidate values, can set as constants, and/or can learn values from training data. In an example, α₂⁰ can be set as a constant zero.

In another example, the error detection component 330 can determine if a slope is near a near vertical lines with very small A₂ such that |αₗₘ| is very large, referred to herein as error type 3. A threshold T₃ can be determined based on the quantization step size of the neighboring blocks, can be a constant, learned using training sequences, and the like. In an aspect, the error detection component 330 can determine the error type 3 has occurred by checking whether A₂<T₃.

When Type 3 problem occurs, the error detection component 330 can replace αₗₘ with an alternative value α₃. The error detection component 330 can determine α₃ and T₃ adaptively from a number of candidate values and sent to the decoder. It is noted that the values can be determined and/or communicated by encoders and/or decoders.

In another example, the error detection component 330 can determine if a slope is reflective of a near vertical lines with A₂ much smaller than |A₁| such that |αₗₘ| is very large, referred to herein as error type 4. A threshold T₄ can be determined based on the quantization step size of the neighboring blocks, can be a constant, learned using training sequences, and the like. In an aspect, the error detection component 330 can determine the error type 4 has occurred by checking whether |αₗₘ|=|A₁|/A₂>T₄.

Error type 4 can be further subdivided into 2P sub-cases for some integer P (e.g. P=1, 2, 3, etc) with the help of 2P threshold values T₄ⁱ where i=±1, ±2, . . . , ±P and 2P alternative values α₄ⁱ, where j=±1, ±2, . . . , ±P. We can choose T₄¹=T₄ and T₄⁻¹=−T₄. For the sub-case T₄ⁱ<αₗₘ<T₄ⁱ⁺¹, αₗₘ is replaced by α₄ⁱ for i=1, 2, . . . , P−1. For the sub-case T₄^{P}<αₗₘ, αₗₘ is replaced by α₄^{P}. For the sub-case Tⁱ⁻¹, 2)<αₗₘ<T₂ⁱ, αₗₘ is replaced by α₂ⁱ for i=−1, −2, . . . , −(P−1). For the sub-case αₗₘ<T₄^{-P}, αₗₘ is replaced by α₄^{-P}. It is noted that the values T₄, α₄ⁱ and T₄ⁱ can be determined and/or communicated by encoders and/or decoders.

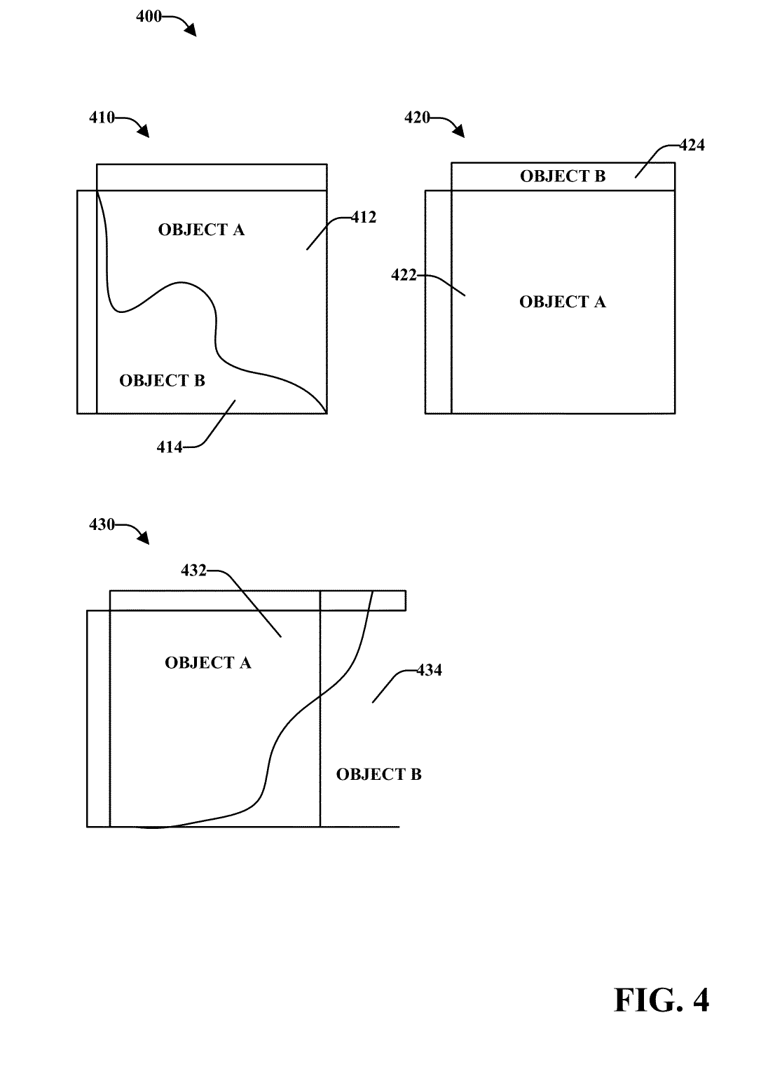

Turning to FIG. 4, there illustrated is a graphical comparison 400 of current blocks in accordance with various embodiments presented herein. In an aspect, a block 410, a block 420, and a block 430 can represent separate current blocks (e.g., 204). Each block can have reference pixels bordering the respective blocks. It is noted that reference pixels need not be adjacent to the blocks, likewise reference blocks can be internal to a current block.

The blocks can comprise one or more objects representing disparate textures, subjects, and/or colors. The same two objects can also be comprised in a L-shape border. In an aspect, a prediction component can determine a prediction mode based on a composition of the blocks and/or the borders. In another aspect, the prediction component can analyze blocks and reference blocks to determine a presence and a position of one or more objects. As an example, a prediction component can determine that the block 410 can comprise an object A 412 and an object B 414. The object A 412 is comprised in a portion of a current block and an above border. The object B 414 can be comprised in a portion of the current block and a side border. The block 420 can comprise an object A 422 and an object B 424. The object A 422 is comprised in a current block and a side border of block 420. The object B 424 can be comprised in an above border of block 420. The object B 414 can be comprised in a portion of the current block and a side border. The block 430 can comprise an object A 432 and an object B 434. The object A 432 is comprised in a portion of a current block, a side border of block 430, and a portion of an above side border. The object B 4234 can be comprised in an portion of the current block of block 430 and a portion of an above side border of block 430.

In an aspect, the prediction component can determine that characteristics of luma and chroma channels. For example, the prediction component can determining a correlation between xₗₘ and yₗₘ in blocks and a correlation between x and y components. For example, a prediction component can determine a strong correlation between luma and chroma in the block 310. In an aspect, a prediction component can determine to utilize a LM mode for the block 310. In another example, a prediction component can determine characteristics between x and y are different in the blocks 320 and 330 from that between xₗₘ and yₗₘ, and can determine that a LM mode is not suitable.

As an example, a prediction component can analyze pixels in an outer border: bₜᵣ, b_{lb} and adjacent borders (bₜ, bₗ—“inner border”). For block 320, the luma-predict-chroma mode may be suitable if bₗ is utilized for prediction, only. For block 330, only the top (bₜ) and top-right pixels (bₜᵣ) can be suitable for prediction. In an aspect, outer border pixels can also be utilized to predict the current block objects that cannot be found in the inner border pixels.

As an example, a prediction component can determine to utilize a LMO, LMA, LML, and/or other prediction modes based on the composition of inner borders, outer borders, and/or current blocks. Accordingly, a prediction component can determine to utilize disparate prediction modes based on the determined compositions.

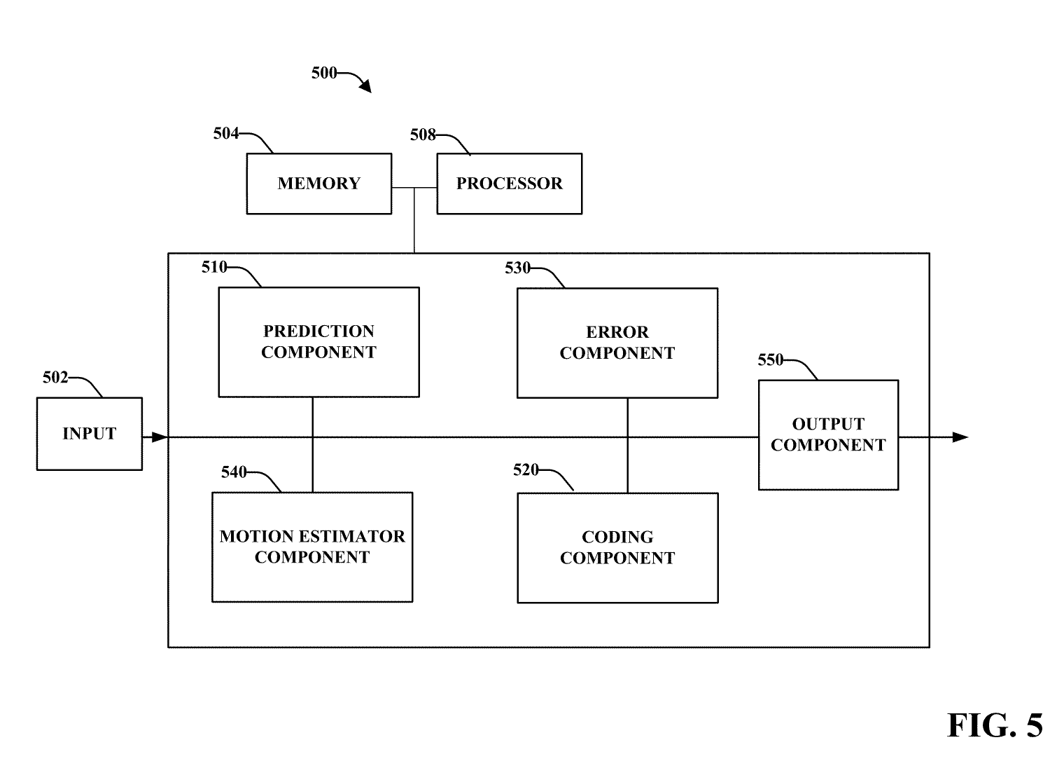

Turning to FIG. 5, presented is a high level schematic diagram of a codec system 500, in accordance with various embodiments described herein. The codec system 500 can include a memory 504, a processor 508, a prediction component 510, a coding component 520, and an error detection component 530, a motion estimator component 540, and an output component 550. Memory 504 holds instructions for carrying out the operations of components, such as the inter-prediction component 510. The processor 508 facilitates controlling and processing all onboard operations and functions of the components. Memory 504 interfaces to the processor 508 for storage of data and one or more applications of, for example, the inter-prediction component 510. The applications can be stored in the memory 504 and/or in a firmware, and executed by the processor 508 from either or both the memory 504 or/and the firmware (not shown). It is noted that the codec system 500 is depicted as a single device but can comprise one or more devices coupled together or across a network.

The system 500 can be configured to employ the various components in order to encode and decode an input 502 over a network with inter-prediction control and fairness management. In particular, the codec system 500 is configured to monitor network traffic and bandwidth utilization of a network. Further, the codec system 500 can determine prediction modes based on an input. In another aspect, the codec system 500 can detect errors during prediction, coding, and the like. The codec system 500 can adjust parameters according to a detected error.

The prediction component 510 can determine a prediction mode based on chroma channels, luma channels, compositions of current blocks, reference blocks, and the like. In an aspect, the prediction component 510 can utilize intra-prediction and/or inter-prediction to predict current blocks. In an aspect, the prediction component 510 can comprise rate distortion optimizers (RDO), hidden markov models (HMM), and the like, to determine a prediction mode to utilize.

The coding component 520 can encode and/or decode a data stream. In an aspect, the coding component 520 can include components for motion estimation, motion compensation, transforming, quantizing, filtering, noise reeducation, and the like. In an aspect, the coding component 520 can utilize various techniques to encode and/or decode data in various formats, such as H.264, HEVC, and the like.

The error detection component 530 can determine an error during encoding, decoding, prediction, and the like. In an aspect, the error detection component 530 can analyze parameters of a data stream to detect an error. In an aspect, the error detection component 530 can adjust parameters (e.g., chroma parameters, luma parameters, and the like) to a correction value. In another aspect, the error detection component 530 can determine thresholds based on an error type. The error detection component can adjust the parameters based on a threshold being met. Likewise, correction values can be adaptively determined, set as constants, and the like.

The motion estimator component 540 can detect motion in a data stream. In an aspect, the motion estimator component 540 can adjust values to compensate for motion, and/or utilized motion prediction techniques.

The output component 550 can output a data stream. In an aspect, the output component 550 can output an encoded data stream when in an encoding mode. In another aspect, the output component 550 can output a decoded media item, such as a video, and/or still images. In an aspect, a media item can be output to an interface, such as a LCD screen, computer monitor, television, and the like.

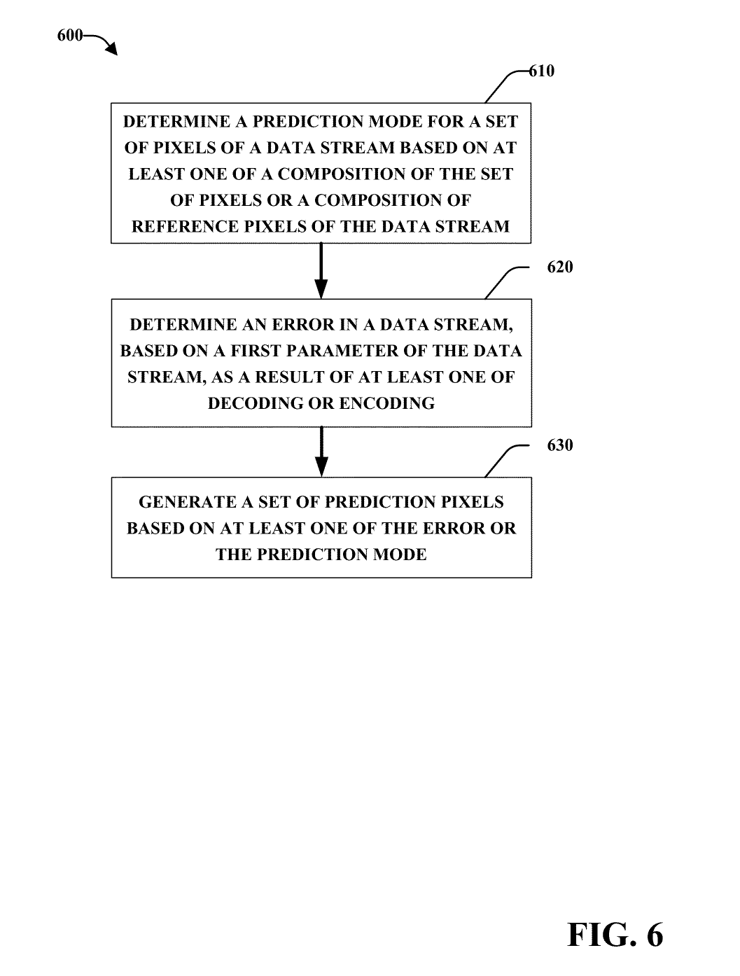

Turning now to FIG. 6, with reference to FIGS. 1-5, there illustrated is an exemplary method 600 to determine a prediction mode for coding of a data stream. In an aspect, method 600 can determine optimal and/or near optimal predicaiton modes based on parameters of a data stream. It is noted that the prediction modes and coding techniques of method 600 result from using various aspects of this diclosure. It is assumed that a system has received input, such as a data stream.

At 610, a system can determine a prediction mode for a set of pixels of a data steam, based on at least one of a composition of the set of pixels or a composition of reference pixels. In an aspect, the set of pixels can comprise a block (e.g., a current block) to be encoded/decoded.

At 620, a system can determine an error in a data stream, based on a first parameter of the data stream, as a result of at least one of decoding or encoding. In an example, an error can be detected due to encoding and/or decoding. In an aspect, the first parameter of the data stream can include A1, A2, αlm, and/or various other parameters as disclosed herein. It is noted that the parameters can comprise reconstructed values of reference pixels and/or values of pixels in the block. In various implementations, errors can be detected as described in FIG. 2-FIG. 5.

At 630, a system can generate a set of prediction pixels based on at least one of the error or the prediction mode. In an aspect, the prediction pixels can be generated by an encoder and/or decoder, for example. It is noted that the various reference pixels can be utilized and/or error correction techniques to generate the prediction pixels.

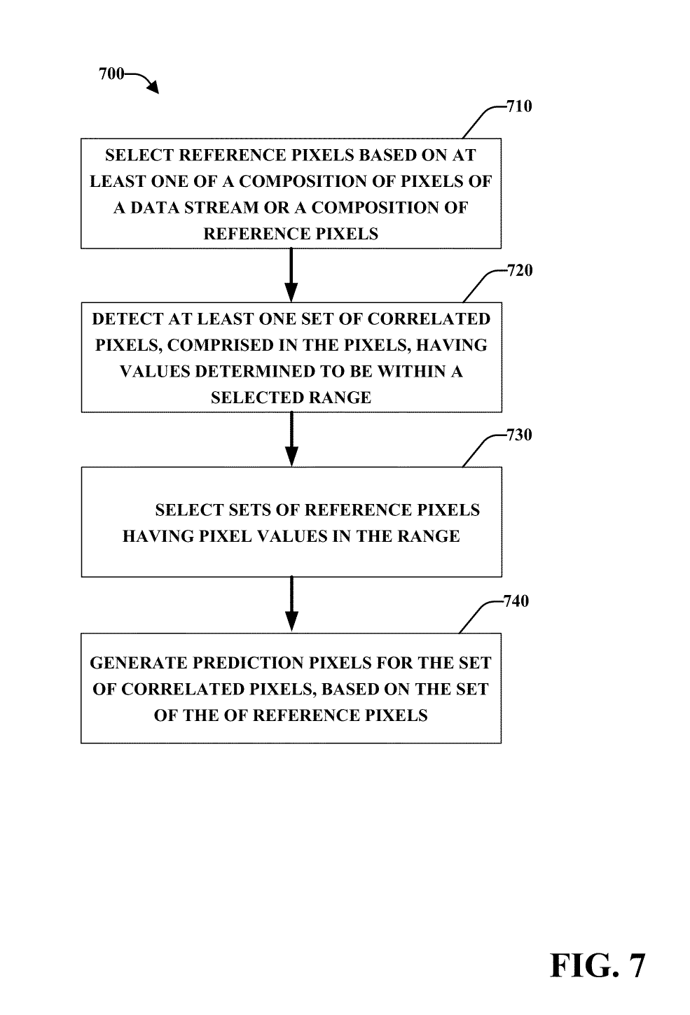

FIG. 7 presents a high level flow diagram of a method 700 for efficient data encoding and/or decoding in accordance with the prediction and error detection schemes of this disclosure.

At 710, a system can select reference pixels based on at least one of a composition of pixels of a data stream or a composition of reference pixels. In an aspect, the pixels of the data stream can comprise current pixels (e.g., pixels to be processed for prediction).

At 720, system can detect at least one set of correlated pixels, comprised in the pixels, having values determined to be within a selected range. In an aspect, the correlation can be pixels of similar and/or identical values. In another aspect, determining a composition can include determining a presence of objects in reference pixels and/or in current pixels (e.g., FIG. 4).

At 730, a system can select sets of reference pixels having pixel values in the selected range. For example, a system can determine an object exists in certain reference pixels and the current block. The system can select the reference pixels that are comprised of all or a portion of the object. It is noted that a system can determine multiple objects exist in a current block and/or in reference blocks and can pair the matching current blocks and reference blocks. It is further noted that selecting the reference pixels can include determining importance levels of pixels through weighting, HMM modeling, and the like.

At 740, a system can generate prediction pixels for the set of correlated pixels, based on the set of reference pixels. It is noted that various aspects of this disclosure can be employed to generate the prediction pixels from the reference pixels.

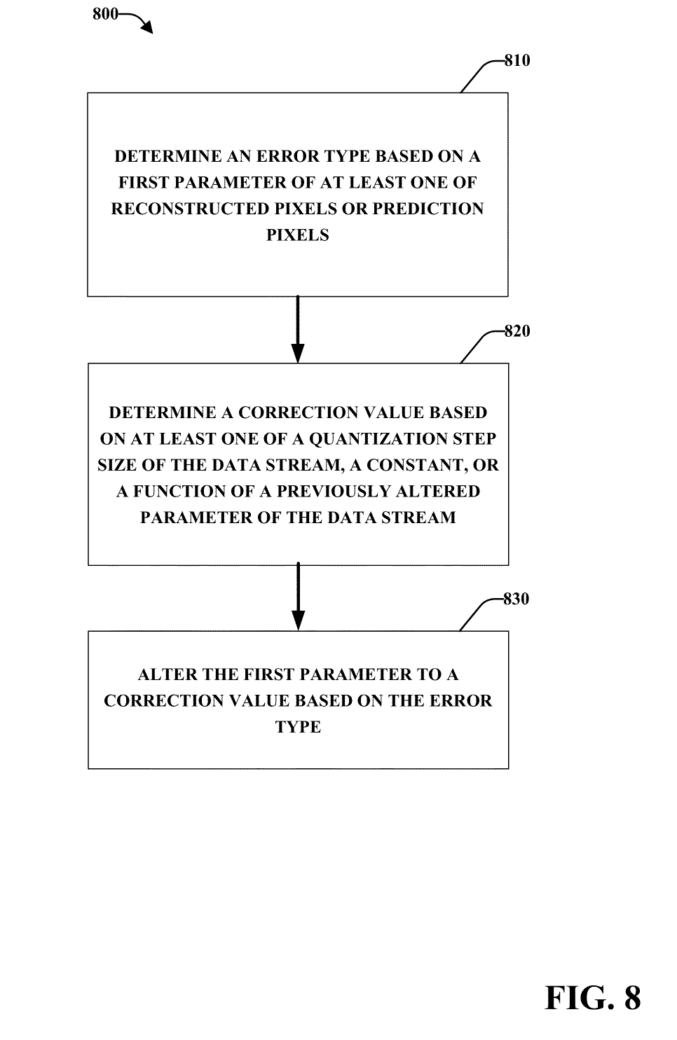

FIG. 8 presents a high level flow diagram of a method 800 for detecting errors while encoding and/or decoding in accordance with the subject coding schemes of this disclosure. It is noted that various systems (e.g., system 100, system 200, system 300, etc.) can provide means for utilizing aspects of the method 800.

At 810, a system can determine an error type based on a first parameter of at least one of reconstructed pixels or prediction pixels. In various implementations, the error type can be based on parameters, such as slopes, offsets, and the like. As an example, a system can determine if an error type 1, error type 2, error type 3, and/or error type 4 has occurred. In an aspect, the first parameter of the data stream can include A1, A2, αlm, and/or various other parameters as disclosed herein. It is noted that the parameters can comprise reconstructed values of reference pixels and/or values of pixels in the block. In various implementations, errors can be detected as described in FIG. 2-FIG. 5.

At 820, a system can determine a correction value based on at least one of a quantization step size of the data stream (e.g., encoding and/or decoding), a constant, or a function of a previously altered parameter of the data stream (e.g., learned from previously reconstructed pixels). In an aspect, the correction value can be a value to replace the parameter and/or alter the parameter (e.g., multiply, etc.).

At 830, a system can alter the parameter to a correction value based on the error type. It is noted that one or more parameters can be corrected based on the correction value.

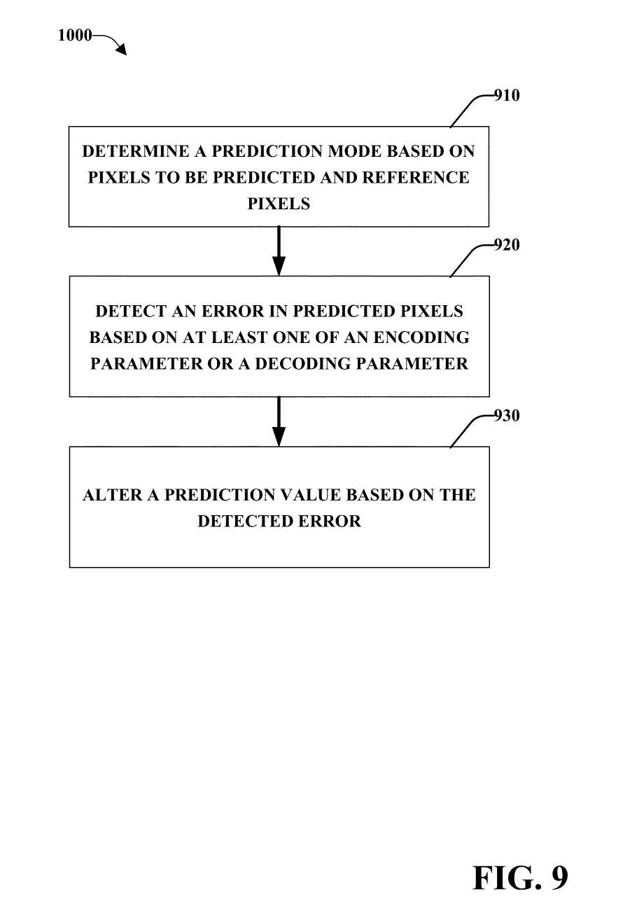

FIG. 9 presents a high level flow diagram of a method 900 for encoding and/or decoding data while in a congestions mode in accordance with the subject prediction and error correction schemes of this disclosure. It is noted that various systems (e.g., system 100, system 200, system 300, etc.) can provide means for utilizing aspects of the method 900.

At 910, a system can determine a prediction mode based on pixels to be predicted and reference pixels. It is noted the pixels can comprise a current block, for example. The system can determine the prediction mode based on determining objects in the pixels also exist in the reference pixels. It is noted that the objects can be identified in accordance with various aspects of this discloser.

At 920, a system can detect an error in predicted pixels based on at least one of an encoding parameters or a decoding parameter. As an example, a system can flag a current block and/or various pixels as an error type. In an aspect, the parameters can include A₁ and A₂, αₗₘ, and the like. Values of the parameters can be compared, for example A₁ and A₂ can be compared to thresholds, and/or each other. Such as when one parameter is much larger than the other, one is near zero, and the like.

At 930, a system can alter a prediction value based on the detected error. In an aspect, various parameters can be altered based on quantization step size of the reference pixels, a constant, a function of parameters of previously altered parameters of the prediction pixels, a learned value, and the like.

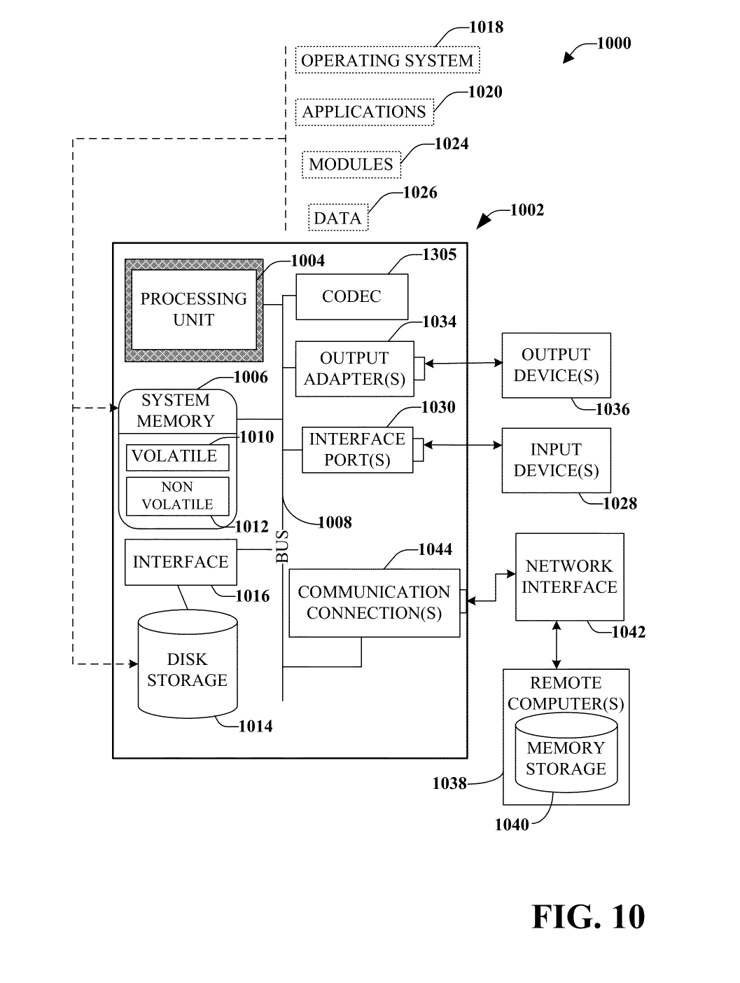

Referring now to FIG. 10, there is illustrated a block diagram of a computer operable to provide networking and communication capabilities between a wired or wireless communication network and a server and/or communication device. In order to provide additional context for various aspects thereof, FIG. 10 and the following discussion are intended to provide a brief, general description of a suitable computing environment 1000 in which the various aspects of the various embodiments can be implemented. While the description above is in the general context of computer-executable instructions that can run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the various embodiments can also be practiced in distributed computing environments where certain tasks are performed by remote processing devices that are linked through a communications network. In a distributed computing environment, program modules can be located in both local and remote memory storage devices.

With reference to FIG. 10, a suitable environment 1000 for implementing various aspects of the claimed subject matter includes a computer 1002. The computer 1002 includes a processing unit 1004, a system memory 1006, a codec 1005, and a system bus 1008. The system bus 1008 couples system components including, but not limited to, the system memory 1006 to the processing unit 1004. The processing unit 1004 can be any of various available processors. Dual microprocessors and other multiprocessor architectures also can be employed as the processing unit 1004.

The system bus 1008 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1094), and Small Computer Systems Interface (SCSI).

The system memory 1006 includes volatile memory 1010 and non-volatile memory 1012. The basic input/output system (BIOS), containing the basic routines to transfer information between elements within the computer 1002, such as during start-up, is stored in non-volatile memory 1012. In addition, according to present innovations, codec 1005 may include at least one of an encoder or decoder, wherein the at least one of an encoder or decoder may consist of hardware, a combination of hardware and software, or software. Although, codec 1005 is depicted as a separate component, codec 1005 may be contained within non-volatile memory 1012. By way of illustration, and not limitation, non-volatile memory 1012 can include read only memory (ROM), programmable ROM (PROM), electrically programmable ROM (EPROM), electrically erasable programmable ROM (EEPROM), or flash memory. Volatile memory 1010 includes random access memory (RAM), which acts as external cache memory. According to present aspects, the volatile memory may store the write operation retry logic (not shown in FIG. 10) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1002 may also include removable/non-removable, volatile/non-volatile computer storage medium. FIG. 10 illustrates, for example, a disk storage 1014. Disk storage 1014 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1014 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1014 to the system bus 1008, a removable or non-removable interface is typically used, such as interface 1016.

It is noted that FIG. 10 describes software that acts as an intermediary between users and the basic computer resources described in the suitable operating environment 1000. Such software includes an operating system 1018. Operating system 1018, which can be stored on disk storage 1014, acts to control and allocate resources of the computer system 1002. Applications 1020 take advantage of the management of resources by operating system 1018 through program modules 1024, and program data 1026, such as the boot/shutdown transaction table and the like, stored either in system memory 1006 or on disk storage 1014. It is noted that the claimed subject matter can be implemented with various operating systems or combinations of operating systems.

A user enters commands or information into the computer 1002 through input device(s) 1028. Input devices 1028 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1004 through the system bus 1008 via interface port(s) 1030. Interface port(s) 1030 include, for example, a serial port, a parallel port, a game port, and a universal serial bus (USB). Output device(s) 1036 use some of the same type of ports as input device(s) 1028. Thus, for example, a USB port may be used to provide input to computer 1002, and to output information from computer 1002 to an output device 1036. Output adapter 1034 is provided to illustrate that there are some output devices 1036 like monitors, speakers, and printers, among other output devices 1036, which require special adapters. The output adapters 1034 include, by way of illustration and not limitation, video and sound cards that provide a means of connection between the output device 1036 and the system bus 1008. It should be noted that other devices and/or systems of devices provide both input and output capabilities such as remote computer(s) 1038.

Computer 1002 can operate in a networked environment using logical connections to one or more remote computers, such as remote computer(s) 1038. The remote computer(s) 1038 can be a personal computer, a server, a router, a network PC, a workstation, a microprocessor based appliance, a peer device, a smart phone, a tablet, or other network node, and typically includes many of the elements described relative to computer 1002. For purposes of brevity, only a memory storage device 1040 is illustrated with remote computer(s) 1038. Remote computer(s) 1038 is logically connected to computer 1002 through a network interface 1042 and then connected via communication connection(s) 1044. Network interface 1042 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1044 refers to the hardware/software employed to connect the network interface 1042 to the bus 1008. While communication connection 1044 is shown for illustrative clarity inside computer 1002, it can also be external to computer 1002. The hardware/software necessary for connection to the network interface 1042 includes, for exemplary purposes only, internal and external technologies such as, modems including regular telephone grade modems, cable modems and DSL modems, ISDN adapters, and wired and wireless Ethernet cards, hubs, and routers.

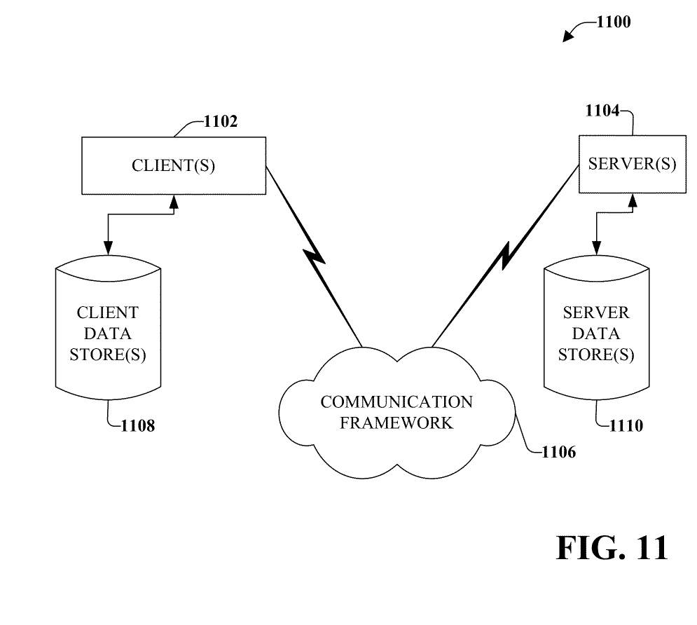

Referring now to FIG. 11, there is illustrated a schematic block diagram of a computing environment 1100 in accordance with this specification. The system 1100 includes one or more client(s) 1102 (e.g., laptops, smart phones, PDAs, media players, computers, portable electronic devices, tablets, and the like). The client(s) 1102 can be hardware and/or software (e.g., threads, processes, computing devices). The system 1100 also includes one or more server(s) 1104. The server(s) 1104 can also be hardware or hardware in combination with software (e.g., threads, processes, computing devices). The servers 1104 can house threads to perform transformations by employing aspects of this disclosure, for example. One possible communication between a client 1102 and a server 1104 can be in the form of a data packet transmitted between two or more computer processes wherein the data packet may include video data. The data packet can include a cookie and/or associated contextual information, for example. The system 1100 includes a communication framework 1106 (e.g., a global communication network such as the Internet, or mobile network(s)) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

In one embodiment, a client 1102 can transfer an encoded file, in accordance with the disclosed subject matter, to server 1104. Server 1104 can store the file, decode the file, or transmit the file to another client 1102. It is noted, that a client 1102 can also transfer uncompressed file to a server 1104 and server 1104 can compress the file in accordance with the disclosed subject matter. Likewise, server 1104 can encode video information and transmit the information via communication framework 1106 to one or more clients 1102.

Various illustrative logics, logical blocks, modules, and circuits described in connection with aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor may be a microprocessor, but, in the alternative, processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. Additionally, at least one processor may comprise one or more modules operable to perform one or more of the s and/or actions described herein.

For a software implementation, techniques described herein may be implemented with modules (e.g., procedures, functions, and so on) that perform functions described herein. Software codes may be stored in memory units and executed by processors. Memory unit may be implemented within processor or external to processor, in which case memory unit can be communicatively coupled to processor through various means as is known in the art. Further, at least one processor may include one or more modules operable to perform functions described herein.

Techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2300, etc. UTRA includes Wideband-CDMA (W-CDMA) and other variants of CDMA. Further, CDMA2300 covers IS-2300, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.23, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA2300 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or elements described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction, and/or data. Additionally, a computer program product may include a computer readable medium having one or more instructions or codes operable to cause a computer to perform functions described herein.

Further, the actions of a method or algorithm described in connection with aspects disclosed herein may be embodied directly in hardware, in a software module executed by a processor, or a combination thereof. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to processor, such that processor can read information from, and write information to, storage medium. In the alternative, storage medium may be integral to processor. Further, in some aspects, processor and storage medium may reside in an ASIC. Additionally, ASIC may reside in a user terminal. In the alternative, processor and storage medium may reside as discrete components in a user terminal. Additionally, in some aspects, the steps and/or actions of a method or algorithm may reside as one or any combination or set of codes and/or instructions on a machine-readable medium and/or computer readable medium, which may be incorporated into a computer program product.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating there from. Therefore, the disclosed subject matter should not be limited to any single embodiment described herein, but rather should be construed in breadth and scope in accordance with the appended claims below.

What is claimed is:

1. A system, comprising:
a processor that executes or facilitates execution of computer executable components stored in a computer readable storage medium, the computer executable components comprising:
an error detection component configured to detect an error, during at least of one encoding or decoding of a data stream, based on a first parameter of the data stream;
a prediction component configured to:
determine a prediction mode based on a second parameter of image pixels of the data stream; and
generate prediction pixels based on the prediction mode; and
a codec component configured to perform at least one of encoding or decoding based on the prediction mode and the error.

2. The system of claim 1, wherein the prediction component is configured to determine the prediction mode in an inter channel prediction mode based on at least one of a composition of current pixels of the data stream or a composition of reference pixels of the data stream.

3. The system of claim 2, wherein the prediction component is further configured to select a set of reference pixels based on at least one of the composition of the reference pixels or the composition of the current pixels.

4. The system of claim 3, wherein the prediction component is further configured to determine the prediction mode for chrominance pixel prediction based on luminance pixels of the a set of reference pixels.

5. The system of claim 1, wherein the error detection component is further configured to determine an error type based on a third parameter of reconstructed pixels of the data stream.

6. The system of claim 5, wherein the error detection component component is further configured to determine the third parameter of the reconstructed pixels based on a slope of a vector of a set of vectors representing the reconstructed pixels.

7. The system of claim 5, wherein the error detection component is further configured to determine the error type based on whether a fourth parameter of prediction pixels is determined to a satisfy a function of a parameter threshold value.

8. The system of claim 5, wherein the error detection component is further configured to alter a fourth parameter of the prediction pixels based on the error type.

9. The system of claim 8, wherein the error detection component alters the fourth parameter of the prediction pixels based on at least one of a quantization step size of the reference pixels, a constant, or a function of a previous alteration of the fourth parameter of the prediction pixels.

10. The system of claim 1, wherein the prediction component is further configured to determine a linear prediction mode that is based in part on selected reference pixels of references pixels of the data stream.

11. A method, comprising:
determining, by a system comprising a processor, a prediction mode for pixels of a data stream based on at least one of a composition of the pixels or a composition of reference pixels of the data stream;
detecting an error in the data stream, based on a first parameter of the data stream, as a result of at least one of decoding or encoding; and
generating a set of prediction pixels based on at least one of the error or the prediction mode.

12. The method of claim 11 further comprising selecting the reference pixels based on at least one of the composition of the pixels or the composition of the reference pixels of the data stream.

13. The method of claim 11 further comprising detecting a set of correlated pixels, from the pixels, having values determined to be within a selected range.

14. The method of claim 13, further comprising:
selecting a set of the reference pixels of the data stream having pixel values in the range; and
generating a set of prediction pixels for the set of correlated pixels based on the set of reference pixels.

15. The method of claim 11, wherein detecting the error further comprises determining an error type based on the first parameter of at least one of reconstructed pixels or the set of prediction pixels.

16. The method of claim 15, wherein the first parameter comprises a slope of a vector representing at least one of the reconstructed pixels or the set of prediction pixels.

17. The method of claim 15, wherein determining the error type comprises determining that a second parameter of the data stream satisfies a function of a threshold defining an error type.

18. The method of claim 17, further comprising altering at least one of the first parameter or the second parameter to a correction value based on the error type.

19. The method of claim 18, further comprising determining the correction value based on at least one of a quantization step size of the data stream, a constant, or a function of a previously altered parameter of the data steam.

20. The method of claim 11, further comprising encoding the set of prediction pixels into the data stream.

21. The method of claim 11, further comprising reconstructing encoded pixels of the data stream based on the prediction mode and the error.

22. A system, comprising:
means for determining a prediction mode as a function of a block of pixels of a data stream, based on at least one of a first parameter of the block of pixels or a second parameter of reference blocks of the data stream;
means for detecting an error in at least one of encoding or decoding of the block of pixels, based on a third parameter of the block of pixels;
means for determining an error type based on the error; and
means for generating a prediction block of pixels for the block of pixels.

23. The system of claim 22, wherein the means for determining the prediction mode comprises means for selecting a set of reference blocks for the prediction mode based on detecting an object in the set of reference blocks and detecting the object in the block of pixels.

24. The system of claim 22, wherein the means for generating the prediction block comprises means for altering a value of the prediction block based on the error type.

25. The system of claim 22, wherein the means for detecting the error comprises means for determining that a fourth parameter of an encoded block satisfies a condition with respect to a threshold.

26. A computer-readable storage medium comprising computer-executable instructions that, in response to execution, cause a device comprising a processor to perform operations, comprising:
determining a prediction mode based on at least one of pixels of a data stream or reference pixels;
detecting an error in predicted pixels that are predicted based on the pixels of the data stream based on at least one of an encoding parameter of the data steam or a decoding parameter of the data stream; and
altering a prediction value based on the error.

27. The computer-readable storage medium of claim 26, wherein the operations further comprise determining a replacement value, based on the error, for altering the prediction value.

28. The computer-readable storage medium of claim 26, wherein the operations further comprise generating the predicted pixels based on at least one of the prediction mode or the error.

29. The computer-readable storage medium of claim 28, wherein the operations further comprise generating reconstruction pixels based on at least one of the prediction mode, the error, or the predicted pixels.
